(19) United States
(12) Patent Application Publication
(10) Pub. No.: US 2021/0328787 A1
(43) Pub. Date: Oct. 21, 2021

(54) PROTECTING SECRET SOFTWARE AND CONFIDENTIAL DATA IN A SECURE ENCLAVE

(71) Applicant: COSMIAN TECH, Paris (FR)

(72) Inventors: Bruno GRIEDER, Clichy (FR); Thibaud GENTY, Paris (FR); Anca NITULESCU, Paris (FR); Michele SARTORI, Paris (FR)

(21) Appl. No.: 17/216,587

(22) Filed: Mar. 29, 2021

(30) Foreign Application Priority Data
Mar. 30, 2020 (FR) 2003137

(51) Int. Cl. H04L 9/08

(52) U.S. Cl. CPC H04L 9/0866; H04L 9/085; H04L 9/0822; H04L 9/0825

(57) ABSTRACT

A method of receiving and executing a secret software (G) on data in a secure enclave of a first device (DO) includes the following steps implemented in the secure enclave, that is to say a step of generating a public key (B), a step of receiving the encrypted secret software (Gₛ) coming from a second device (AP), a step of decrypting the encrypted secret software (Gₛ) from a key (K; P) depending of the public key (B, a step of receiving data; and a step of executing the secret software (G) using the data.

### CROSS REFERENCE TO RELATED APPLICATIONS

This application claims priority under 35 U.S.C. § 119(a) to French patent application 2003137 filed on Mar. 30, 2020, the entire teachings of which are incorporated herein by reference.

### BACKGROUND OF THE INVENTION

### Field of the Invention

The present invention relates to a secure and reliable manner to execute a secret software of a third-party device. In particular, the invention relates to the reception of a secret software from a second device and the execution of this secret software on data in a secure enclave of a first device in such a way that the first device cannot access the secret software.

### Description of the Related Art

Due to the progress of digital technology, the different industries accumulate more and more data about their clients, their business partners, their internal processes, etc. However, they often do not have the means to efficiently use and analyze these data.

For example, a data owner or provider may be a hospital that accumulate data about its patients and may want to make evaluations and statistics on these data to deduce medical conclusions. Generally, hospitals have neither the know-how nor the software to make such evaluations. They hence need to have recourse to a third party. To do this, it is necessary to provide the data to this third party, which will make evaluations and statistics on these data by executing suitable software. As an alternative solution, the third party can provide suitable software to the data owner in such a way that the latter can make itself the evaluations and statistics on the data.

However, these two approaches suffer from drawbacks.

Providing data to a third party is very often problematic because these data may contain sensitive or private information that must not be shared with a third party. In some cases, this problem may be solved by anonymizing the data previously to providing them to the third party. It is possible to anonymize, for example, text data, such as names or addresses that must be hidden. Nevertheless, this anonymizing operation is expensive and difficult to carry out. It is expensive in particular in that data analyzes are required to identify the sensitive information, then to execute algorithms for anonymizing these data. However, in some cases, it is impossible to anonymize the sensitive information. This is the case, for example, when the data are composed of images containing sensitive information.

Providing software to the data owner also pose another problem, namely that the data owner will have access to the software without any check on the number of executions of the software nor any control of the latter can be carried out. Thus, a data owner could easily give out the software to other data owners or perform “reverse-engineering” operations of this software.

Documents US 2016/210445 and WO 97/25675 disclose solutions for protecting the access to a software, but that do not address these drawbacks.

### BRIEF SUMMARY OF THE INVENTION

The object of the invention is to address the drawbacks of the prior arts.

This object is achieved by a method of receiving and executing a secret software on data in a secure enclave of a first device. This method includes the following steps implemented in the secure enclave:
generating a public key;
receiving the encrypted secret software from a second device;
decrypting the encrypted secret software from a key depending on the public key;
receiving data; and
executing the secret software using the data.

The method can further include the following steps implemented in the secure enclave:
generating a certificate including information relating to the secure enclave;
sending the certificate to a trusted device in order to allow the trusted device to carry out a control of the information relating to the secure enclave, and
the step of receiving the encrypted secret software from the second device can then be implemented after control of the certificate by the trusted device.

The information relating to the secure enclave can include in this case information relating to the public key and the step of sending the certificate to the trusted device can then allow the trusted device to control the generation of the public key in the secure enclave.

The information relating to the secure enclave can also include a fingerprint relating to the secure enclave; and the step of sending the certificate to the trusted device can then allow the trusted device to control the integrity of the secure enclave of the first device.

The method can further include the following steps implemented in the secure enclave:
a step of generating a secret value and the step of generating the public key is carried out from the secret value;
a step of sending the public key to the second device in order to allow the second device to create a symmetric key depending on the public key and to encrypt the secret software with the symmetric key;
a step of receiving a first partial key coming from the second device;
a step of generating the symmetric key, from the first partial key and the secret value; and
the step of decrypting the encrypted secret software can then be carried out from the symmetric key.

In this case, the secure enclave can include a master key and the method can then further include a step of encrypting the symmetric key or the secret value implemented in the secure enclave, from the master key, the encrypted symmetric key or the encrypted secret value being memorized in a device other than the secure enclave. The step of deciphering the encrypted secret software can then be preceded by a step of obtaining the encrypted symmetric key and a step of decrypting the encrypted symmetric key or the encrypted secret value from the master key in order to obtain the symmetric key or the secret value.

According to an alternative embodiment, the step of decrypting the encrypted secret software can be carried out from a private key of a pair of asymmetric keys, the pair of asymmetric keys being formed of the public key and the associated private key.

In this case, the secure enclave can include a master key. The method can then further include a step of encrypting the private key implemented in the secure enclave, from the master key, the encrypted private key being memorized in a device other than the secure enclave. The step of decrypting the encrypted secret software can then be preceded by a step of obtaining the encrypted private key and a step of decrypting the encrypted private key from the master key in order to obtain the private key.

In all the preceding cases, the first device can receive a software execution environment and install the software execution environment in order to initialize the secure enclave.

In this latter case, the software execution environment can be signed and the first device can check the integrity of the software execution environment previously to the installation of the software execution environment.

The software execution environment can come from the second device or from a third device.

In this case, the third device can be a storage device memorizing the software execution environment adapted to be connected directly to the first device or to be linked to the first device by means of a communication network.

The software execution environment can then include secret software execution control measures.

In this last case, the secret software execution control measures can include a counter for controlling and/or limiting the number of executions of the secret software.

The secret software execution control measures can also include a control of the hardware environment on which the secure enclave is installed.

In any case, the first device can include a set of data and the step of receiving data implemented in the secure enclave can include the reception of all or part of the set of data of the first device.

As an alternative, the step of receiving data implemented in the secure enclave can include the reception of data from a device other than the first device.

The invention has also for object a method of remote execution, in a secure enclave of a first device, of a secret software on data of a second device. The method includes the following steps implemented in the second device:
obtaining a public key of the secure enclave of the first device,
encrypting the secret software from a key depending on the public key; and
sending the encrypted secret software to the secure enclave of the first device for its decryption and execution using data in the secure enclave.

The method can further include a step, implemented in the second device, of receiving a result, from a trusted device, of a control of information relating to the secure enclave; the step of sending the encrypted secret software can be implemented after the result of the certificate control by the trusted device has been received.

The method can also further include the following steps implemented in the second device:
a step of generating a secret value and a first partial key from the secret key;
a step of generating a symmetric key, from the public key and the secret value;
the step of encrypting the secret software is carried out from the symmetric key; and
a step of sending the first partial key to the secure enclave of the first device in order to allow the secure enclave of the first device to create a symmetric key depending on the partial key and to decrypt the secret software with the symmetric key.

The secret software can then be encrypted with the public key in order to be adapted to be decrypted in the secure enclave with a private key of the secure enclave.

The method can also further include a step of sending a software execution environment to the first device, to allow the initialization of the secure enclave in the first device.

In this case, the method can further include a step of generating the software execution environment or a step of receiving the software execution environment from a third device.

The method can also further include a step of signing the software execution environment in order to allow the first device to check the integrity of the software execution environment previously to the installation of the software execution environment.

The software execution environment can include secret software execution control measures.

In this case, the secret software execution control measures can include a counter for controlling and/or limiting the number of executions of the secret software.

The secret software execution control measures can also include a control of the hardware environment on which the secure enclave is installed.

In all the above cases, the sending and receiving steps between the first device, the second device and the trusted device can be carried out by means of a communication network.

The invention has also for object a device configured to implement one of the previously described methods.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 illustrates a method of receiving and executing a secret software on data in a secure enclave of a first device.

FIG. 2 illustrates a method of receiving and executing a secret software on data in a secure enclave of a first device using a symmetric key for the encryption of the secret software.

FIG. 3 illustrates a method of receiving and executing a secret software on data in a secure enclave of a first device using asymmetric keys for the encryption of the secret software.

### DETAILED DESCRIPTION OF THE INVENTION

The present invention relates to a secure and reliable manner to execute a secret software belonging to a software provider on a device that do not belong to this software provider. In particular, the invention relates to the reception of a secret software from a second device, for example belonging to the software provider, and the execution of this secret software on data in a secure enclave of a first device (third-party device). That way, the access to the secret software is possible only to the secure enclave of the first device but not out of the secure enclave of the first device.

A secret software can include one or several secret algorithms adapted to be executed on data. For the software to be kept secret, it is encrypted before being transmitted to a secure enclave in such a way that third parties cannot access the software. The access to the software includes in particular the execution of the software or an analysis of the software, for example by means of a “reverse-engineering”.

A secure enclave is a hardware and software technology designed to securely process data. The secure enclave allows a secure execution of software on data, in such a way that even a user having the highest privileges, such as those of an administrator, cannot see what happens inside the secure enclave or in the memory (RAM) of the secure enclave. In other words, even a person having a physical access to the secure enclave cannot access the enclave-specific data (such as cryptographic keys or execution parameters) nor perform analysis of the software program(s) adapted to be executed in the enclave. The hardware architecture of the secure enclave can include one or several processors. According to an embodiment, only these processors are adapted to decrypt the secure enclave-specific data. The encryption and decryption of the secure enclave-specific data can be performed using a hardware key (master key) V memorized in the secure enclave and accessible only to the processor(s) of the secure enclave. According to a particular example, the master key V is engraved on the processor(s) and cannot be read by software or hardware attacks, except if the processor(s) are destroyed.

The secure enclave hence allows receiving an encrypted secret software and data that are used by the latter. The secure enclave can decrypt the secret software and execute it using data. Such a solution allows keeping the software secret, that is to say that no “reverse-engineering” operation can be performed on this software.

An example of secure enclave includes the implementation of the “Intel” (registered trademark) technology, known as “SGX”. This technology allows the secure execution of a software (or software code) in a reliable execution environment.

FIGS. 1 to 3 illustrate methods of receiving and executing a secret software on data in a secure enclave of a first device in accordance with the invention. In these figures, the dotted blocks refer to optional features that are indispensable to the execution of the secret software.

FIG. 1 illustrates a method of receiving and executing a secret software on data in a secure enclave of a first device (called data owner device DO).

The secure enclave 10 is illustrated in the Figures as being directly integrated in the data owner device DO. According to an alternative embodiment, the secure enclave 10 can be connected to the data owner device DO, for example through a computer bus or a network.

The method includes a step 101 of generating a public key B in the secure enclave 10. Then, the secure enclave 10 can, in a step 102, generate a certificate including information relating to the secure enclave 10. The information relating to the secure enclave can include information relating to the public key B and/or a footprint relating to the secure enclave 10 and/or information relating to the hardware environment of the secure enclave (for example, the identifier of the processor(s)).

Third parties can access the public key B in order to encrypt a secret software G. In particular, a second device (called software provider device) AP can acquire the public key B (step 201) in order to encrypt the secret software G by means of this key. The public key B can be communicated to the second device AP by the secure enclave 10 via the data owner device DO and/or by means of another device (for example, a public key infrastructure).

In the embodiment in which the secure enclave 10 generates a certificate, the method includes a step 103 of sending the certificate to a trusted device 30 in order to allow this device to carry out a control of the information relating to the secure enclave 10. This sending can be performed directly from the secure enclave to the trusted device 30 or through the data owner device DO and/or other devices and can be performed by means of a communication network (for example, Internet). The trusted device 30 receives the certificate in a step 301 and carries out a control of the information relating to the secure enclave 10 in a step 302.

If the information relating to the secure enclave includes information relating to the public key B, the trusted device 30 can control the generation of the public key B. Therefore, the trusted device 30 can check and confirm that the public key B has indeed been created in the secure enclave 10 and that the secure enclave is the single entity (in some cases, with the software provider AP) that has a decryption key K, P depending on the public key B.

If the information relating to the secure enclave 10 includes a footprint relating to the secure enclave 10, the trusted device 30 can control the integrity of the secure enclave of the data owner device DO. This control makes it possible to check that the secure enclave is intact and not-modified. In some cases, the trusted device 30 can be the builder, the manufacturer or the provider of the secure enclave 10. The control of integrity of the secure enclave can be carried out using information memorized in the trusted device 30 before the delivery of the secure enclave to a client.

Finally, the trusted device 30 can communicate the result of the control to the software provider device AP (step 303) so that the latter can check that the secure enclave 10 is effectively secured and that the public key effectively belongs to the secure enclave.

In a step 202, the software provider device AP can, previously to the sending of the encrypted secret software (or even before encrypting the secret software), receive the control result of the trusted device 30 and evaluate the security of the secure enclave and of the public key B based on the control result. If the software provider device AP decides that the secure enclave 10 is not secure enough, it won't send the encrypted secure software Gₛ. This control mechanism prevents in particular that a fraudulent secure enclave can access the secret software in clear (not encrypted). If it decides that the secure enclave 10 is secure enough, it encrypts (step 203) and sends (step 204) the encrypted secret software Gₛ to the secure enclave 10, for its decryption and execution using data in the secure enclave 10. The encryption of step 203 is carried out using the public key B. The sending of the encrypted secret software Gₛ to the secure enclave 10 (step 204) can be carried out via the data owner device DO and/or via another device connected to the secure enclave 10.

At step 104, the secure enclave 10 receives the encrypted secret software Gₛ from the software provider AP. After the reception of the encrypted secret software Gₛ, the secure enclave 10 decrypts the encrypted secret software Gₛ from a key K, P depending on the public key B in a step 105. The decryption key K, P is known by the secure enclave 10 and not by the data owner device DO. Different examples of encryption schemes are explained by means of FIGS. 2 and 3.

At the following step (step 106), the secure enclave 10 receives data to be processed by the secret software. The data can come from a set of data memorized in the data owner device DO. The data received by the secure enclave 10 can contain all the data of this set of data or only a part of this set. Moreover or as an alternative, the secure enclave can receive data from a device other than the data owner device DO, in particular a remote device. In this last case, the data can be encrypted by the remote device before being sent to the secure enclave, then decrypted in the enclave. This encryption can be carried out similarly to the encryption of the secret software, in particular by means of the public key B.

Step 106 is followed by step 107, in which the secret software G is executed by the secure enclave 10 using the received data.

The steps described hereinabove can be executed in a different order. For example, the reception of the data in the secure enclave can be a first step of the method.

According to a particular embodiment, previously to the execution of the secret software Gin the secure enclave 10 (step 107), preferably even previously to the generation of the certificate (step 102), the data owner device DO receives a software execution environment E and installs this software execution environment E in order to initialize the secure enclave 10 (step 100). The installation of the software execution environment E previously to the generation of the certificate (step 102) has for advantage that the creation of the footprint relative to the secure enclave 10 can take into account the installed software execution environment E. Hence, the installation of the software execution environment E can be validated by the trusted dispositive 30.

The software execution environment E can include, in addition to the software environment allowing the initialization of the secure enclave, libraries required for the execution of the secret software G and/or parameters specific to the execution of the software G (for example, initial configurations of the software, etc.). Moreover, the software execution environment E can include secret software execution control measures G. These secret software execution control measures G can include a counter for controlling and/or limiting the number of executions of the secret software G. The secret software execution control measures G can also or alternatively include a control of the hardware environment on which is installed the secure enclave. For example, the control measures can limit the resources used during the execution of the secret software G, as for example the number of processors and/or the quantity of memory.

According to an embodiment, the software execution environment E can be sent from the software provider device AP to the data owner device DO (step 200 and step 100). For that purpose, the software execution environment E can be generated by the software provider device AP or by another device and received by the software provider device AP.

According to another embodiment, the software execution environment E received by the data owner device DO can come from a device other than the software provider device AP (step 100). For example, the software execution environment E can come from a storage device memorizing the software execution environment E, adapted to be connected directly to the data owner device DO. This storage device can be, for example, a memory medium such as a USB key. As an alternative, the other device can be linked to the data owner device DO by means of a communication network.

The software execution environment E can be signed, generally by the device that provides the software execution environment E, for example by the software provider device AP. Therefore, the data owner device DO can check the integrity of the software execution environment E previously to the installation of the software execution environment E.

FIG. 2 illustrates a method of receiving and executing a secret software on data in a secure enclave of a first device using a symmetric key for the encryption of the secret software.

Only the steps that are different from those of the method illustrated in FIG. 1, hence the steps linked to the encryption and decryption, will be described in detail hereinafter. For the rest, reference will be made to the method illustrated in FIG. 1.

The method based on the use of a symmetric key further includes a step 108 of generating a secret value b. In this embodiment, the public key B (step 101a) is generated from the secret value b in the secure enclave 10. In this case, the public key B can be a partial key. The secret value b can be a random value and the public key B can be generated as follows: B=g^{b}, g being a generator of a finite group.

At step 109, the secure enclave 10 can send the public key B to the software provider device AP in order to allow the software provider device AP to create a symmetric key K depending on the public key B and to encrypt the secret software G with the symmetric key K. The public key B can be transmitted from the secure enclave 10 to the software provider device AP via other devices, such as key management devices. The software provider device AP hence access the public key B or receives it in a step 210a.

During a step 205, the software provider device AP can generate a secret value a and a first partial key A from the secret value a. The secret value a can be a random value and the partial key A can be generated as follows: A=g^{a}, g being a generator of a finite group. The software provider device AP can then send the partial key A (step 206) to the secure enclave in order to allow the secure enclave to create the symmetric key K depending on the partial key A and to decrypt the encrypted secret software Gₛ with the symmetric key K. The partial key A can be transmitted from the software provider device AP to the secure enclave 10 via other devices, such as key management devices. According to a particular embodiment, the transmission of the partial key A can be made simultaneously with the transmission of the software execution environment E.

At step 207, the software provider device AP can use the public key B received from the secure enclave 10 and the secret value a to generate the symmetric key K. The generation can be carried out as follows: K=B^{a}=g^{ba}, g being a generator of a finite group.

At step 110, the secure enclave 10 can receive the first partial key A coming from the software provider device AP.

At step 111, the secure enclave 10 can generate the symmetric key K from the first partial key A received from the software provider device AP and from the secret value b. The generation can be carried out as follows: K=A^{b}=g^{ab}, g being a generator of a finite group.

The encryption of the secret software G in the software provider device AP is carried out from the symmetric key K at step 203a.

The decryption of the encrypted secret software Gₛ in the secure enclave 10 can be carried out from the symmetric key K at step 105a.

The secure enclave 10 can also include a master key V. The master key V can be used to encrypt secret information of the secure enclave 10 in order to memorize that information outside the secure enclave 10, for example on the data owner device or on another device.

Therefore, the secure enclave 10 can also include a step 112a of encrypting the symmetric key K or the secret value b from the master key V. The symmetric key or the encrypted secret value can hence be memorized in a device other than the secure enclave 10.

In this case, the secure enclave 10 must obtain the encrypted symmetric key or the encrypted secret value to decrypt the encrypted symmetric key or the encrypted secret value from the master key V in a step 113a and obtain the symmetric key K or the secret value b, previously to the decryption of the encrypted secret software Gₛ.

FIG. 3 illustrates a method of receiving and executing a secret software on data in a secure enclave of a first device using asymmetric keys for the encryption of the secret software.

Only the steps that are different from those of the method illustrated in FIG. 1, hence the steps linked to the encryption and decryption, will be described in detail hereinafter. For the rest, reference will be made to the method illustrated in FIG. 1.

The software provider device AP encrypts the secret software with the public key B during step 203b in order for it to be able to be decrypted in the secure enclave 10 with a private key P of the secure enclave 10 of a pair of asymmetric keys. This pair of asymmetric keys is formed of the public key B and the associated private key P.

The secure enclave 10 decrypts in a step 105b the encrypted secret software Gₛ from the private key P.

The private key P can be generated for example at step 101b during the generation of the public key B. As an alternative, the private key P can be a hardware key of the secure enclave.

In the embodiment using a pair of asymmetric keys, the secure enclave 10 can include a master key V and use this master key V to encrypt the private key P implemented in the secure enclave in a step 112b. The encrypted private key can hence be memorized in a device other than the secure enclave. In this case, the secure enclave 10 must, before the decryption of the encrypted secret software Gₛ, obtain the encrypted private key and decrypt it from the master key V in order to obtain the private key P (step 113b).

The software provider device AP, the data owner device DO and the trusted device 30 can be computer devices including a memory configured to store instructions allowing the execution of the instructions illustrated in FIGS. 1 to 3. Moreover, these computer device can include one or several processors for processing the instructions stored in memory.

The software provider device AP, the data owner device DO and the trusted device 30 can be connected communicatively through a computer bus system or a wired or wireless communication network, for example Internet.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method of receiving and executing a secret software on data in a secure enclave of a first device, comprising the following steps implemented in the secure enclave:
generating a public key;
receiving the encrypted secret software from a second device;
decrypting the encrypted secret software from a key depending on the public key;
receiving data; and
executing the secret software using the data.

2. The method according to claim 1, characterized in that the method further comprises the following steps implemented in the secure enclave:
generating a certificate comprising information relating to the secure enclave;
sending the certificate to a trusted device in order to allow the trusted device to carry out a control of the information relating to the secure enclave; and
the step of receiving the encrypted secret software from the second device is implemented after control of the certificate by the trusted device.

3. The method according to claim 2, characterized in that the information relating the secure enclave comprises information relating to the public key; and the step of sending the certificate to the trusted device allows the trusted device to control the generation of the public key in the secure enclave.

4. The method according to claim 2, characterized in that the information relating the secure enclave comprises a footprint relating to the secure enclave; and the step of sending the certificate to the trusted device allows the trusted device to control the integrity of the secure enclave of the first device.

5. The method according to claim 1, characterized in that the method further comprises the following steps implemented in the secure enclave:
a step of generating a secret value and the step of generating the public key is carried out from the secret value;
a step of sending the public key to the second device in order to allow the second device to create a symmetric key depending on the public key and to encrypt the secret software with the symmetric key;
a step of receiving a first partial key coming from the second device;
a step of generating the symmetric key, from the first partial key and the secret value; and
the step of decrypting the encrypted secret software is carried out from the symmetric key.

6. The method according to claim 5, characterized in that the secure enclave comprises a master key; and the method further comprises
a step of encrypting the symmetric key or the secret value implemented in the secure enclave, from the master key, the encrypted symmetric key or the encrypted secret value being memorized in a device other than the secure enclave; and
the step of deciphering the encrypted secret software is preceded by a step of obtaining the encrypted symmetric key and a step of decrypted the encrypted symmetric key or the encrypted secret value from the master key in order to obtain the symmetric key or the secret value.

7. The method according to claim 1, characterized in that the step of decrypting the encrypted secret software is carried out from a private key of a pair of asymmetric keys, the pair of asymmetric keys being formed of the public key and the associated private key.

8. The method according to claim 7, characterized in that the secure enclave comprises a master key; and
the method further comprises a step of encrypting the private key implemented in the secure enclave, from the master key, the encrypted private key being memorized in a device other than the secure enclave; and the step of decrypting the encrypted secret software is preceded by a step of obtaining the encrypted private key and a step of decrypting the encrypted private key from the master key in order to obtain the private key.

9. The method according to claim 1, characterized in that the first device receives a software execution environment and installs the software execution environment in order to initialize the secure enclave.

10. The method according to claim 9, characterized in that the software execution environment comes from the second device or a third device.

11. The method according to claim 9, characterized in that the software execution environment comprises secret software execution control measures.

12. The method according to claim 11, characterized in that the secret software execution control measures comprise a counter for controlling and/or limiting the number of executions of the secret software.

13. The method according to claim 1, characterized in that the data receiving step implemented in the secure enclave comprises the reception of data from a device other than the first device.

14. A method of remote execution, in a secure enclave of a first device, of a secret software on data of a second device, characterized in that it comprises the following steps implemented in the second device:
obtaining a public key of the secure enclave of the first device;
encrypting the secret software from a key depending on the public key; and
sending the encrypted secret software to the secure enclave of the first device for its decryption and execution using data in the secure enclave.

15. A device configured to implement the method according to claim 1.
